(19) United States
(12) Patent Application Publication
(10) Pub. No.: US 2015/0135725 A1
(43) Pub. Date: May 21, 2015

(54) GAS-TURBINE ENGINE

(71) Applicant: Vladimir Iosifovich BELOUS, (US)

(72) Inventor: Vladimir Iosifovich Belous, Gomel (BY)

(21) Appl. No.: 13/261,958

(22) PCT Filed: Mar. 26, 2013
(86) PCT No.: PCT/BY2013/000002

§ 371 Date: Sep. 25, 2014

(30) Foreign Application Priority Data
Mar. 30, 2012 (BY) A20120506

(51) Int. Cl. F02C 3/107; F02C 9/18

(52) U.S. Cl. CPC F02C 3/107; F02C 9/18
USPC 60/791

(57) ABSTRACT

This invention relates to gas turbine engines of continuous combustion in a high speed gas flow through an open circuit in high heating value gas turbine fuels. It may be used in transportation facilities, such as aviation and power plants, and also as a drive in gas compressor units.

The engine contains two or more combustion chambers for high-calorific fuel suitable for combustion in speed gas and air stream. Each combustion chamber after the previous combustion chamber raises the temperature of the working body after the work at the turbine stage to the value optimal for work at next turbine stage. There is a possibility of independent reallocation of immediate bulk flows between the main stream of the working body and supplementary bypass parallel streams of the working body. For this purpose the engine, apart from the multistaged turbine, contains at least two compressor stages of air compression with bends. Each combustion chamber contains its fuel sprayers.

This invention relates to gas turbine engines of continuous combustion in a high speed gas flow through an open circuit in high heating value gas turbine fuels. It may be used in transportation facilities, such as aviation and power plants, and also as a drive in gas compressor units.

The power plant to produce electricity from coal gasification under pressure in compliance with Patent Document U.S. Pat. No. 4,199,933 is known. In this plant the hot gas which requires further combustion is fed simultaneously at a high pressure turbine from the gasifier, and by it to the combustion chamber of low pressure. And further in the low-pressure turbine and then exits into the atmosphere. This method of fuel gas afterburning is only suitable for low heating value gas which is formed, for example, in the gasifier by means of coal gasification under pressure.

Patent Document U.S. Pat. No. 5,103,630 is known. Fuel is burned in the pre-conditions of oxygen deficiency in the high pressure combustion chamber with subsequent pass through the turbine stage. And further with gas afterburning in the combustion chamber of low pressure, followed by work on the turbine stage and release into the atmosphere. This method of combustion is also suitable only for low calorific fuel. In the case of high calorific fuel it's required a lot of pressure stages of secondary air supply for full fuel afterburning. As long as the fuel mass flow becomes less than 5% of the total flow of the working fluid at the engine outlet. Or it will be required to enter the water supply to the combustion chambers.

The prototype assembly for fuel combustion in a gas turbine engine according to Patent Document GB2288640 is also known. This engine is equipped with four consecutive compressors and four consecutive turbines. It is required to supply two times less air than that is required for complete fuel combustion in the combustion chamber of the engine. Further, in the downward stream direction, it is proposed to make a multistep afterburning during the operation of the working fluid on the stages of the turbine. It should be noticed that in case of use of the conventional high calorific gas turbine fuel, gas temperature before the first stage of the turbine is unacceptably high. Since the unburned half of the fuel will not be able to reduce the combustion products temperature to acceptable levels.

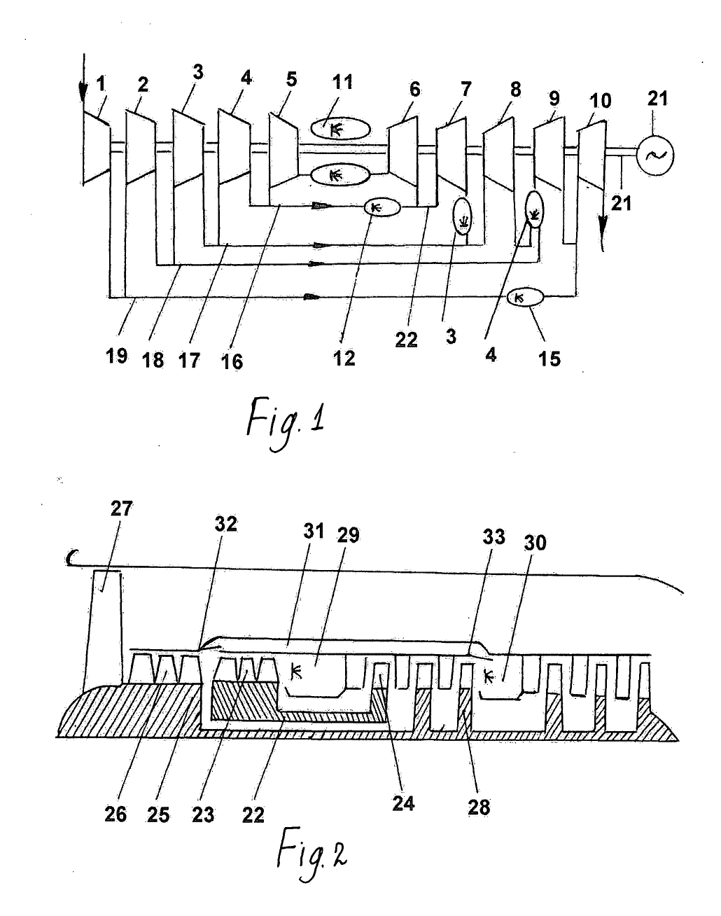

It is offered a different way to achieve the most complete step-combustion of high calorific fuel and atmospheric oxygen in the gas turbine engine. For this purpose it's proposed to mix the conventional combustion products of high calorific fuel for the first stage of high pressure turbine having, for example, an excess oxygen ratio of about 3, with the additional parallel bypass flow of partially burned fuel in the deficiency of oxygen in the combustion chamber of low pressure. After this mixing and reacting of the afterburning of the unburned fuel, the temperature of the working fluid flow rises to the required value again, for example, up to 1200 K. After operation on the second stage of the turbine it is offered again the same procedure of mixing and afterburning before the third stage of the turbine. As a result of this arrangement of the engine from stage to stage the degree of excess oxygen in the working fluid of the engine will decrease sequentially. For example, after the fourth stage of the turbine the excess oxygen ratio can be equal to 1, i.e. almost all air oxygen will be burned. Then this working fluid flow should be mixed with the additional bypass flow of working fluid of the corresponding pressure and temperature from the respective combustion chamber of low pressure. As a result, the temperature of the working fluid flow before the fifth and last turbine stage is also maintained at a high level. As a result of fivefold heat, supply to the working fluid the engine efficiency is about 80%. Exhaust gases temperature rises, for example, up to 1000 K. The engine power increases per unit weight. To produce parallel air flows of corresponding pressure it's offered to use the appropriate compressor stages of corresponding mass air flow. Mass flow rate of additional parallel bypass flows of the working fluid can be, for example, of a few percent to the main propellant flow. In this case, there will be provided the opportunity of free redistribution of working fluid flow rate between the main stream and additional one. That will make the combustion process in the combustion chambers reliable and without longitudinal self-oscillation. In contrast with known gas turbine engines with intermediate heating of the working fluid when burning of high calorific fuels. The diagram of FIG. 1 shows three possible variants of the particular arrangement of the combustion chamber of low pressure. In all three versions there is a possibility of free redistribution of working fluid flow rate between the main flow of the working fluid and an additional bypass flow that should eliminate the possibility of vibration combustion in the combustion chambers of the engine. It is proposed to use the appropriate oil products such as gas turbine and turbojet liquid fuel, liquefied gas, natural gas or shale gas as high calorific fuel. The heat of combustion of such fuels is over 43,000 kJ/kg.

The FIG. 1 shows a diagram of a gas turbine engine to generate electricity with various variants of bypassing of the working fluid at the appropriate pressure turbine stage. The FIG. 2 shows the diagram of a subsonic aircraft gas turbine engine with an intermediate heating of the working fluid.

The gas turbine engine for electricity producing shown in FIG. 1 is equipped with compressors 1, 2, 3, 4, 5 and turbines 6, 7, 8, 9, 10. High-pressure combustion chamber 11 is positioned between high pressure compressor 5 and high pressure turbine 6. Low-pressure combustion chamber 12 with its input connected to the output of the compressor 4 and with the outlet to the turbine stage 7. Low pressure combustion chamber 13 is connected together with the outlet of compressor 3 to the input of turbine stage 8 by means of its outlet, and the input of the chamber is connected to the output of turbine stage 7. Low pressure combustion chamber 14 is connected to the input of turbine 9 by means of its output and by means of the input it is connected to the output of compressor 2 and the output of turbine 8. Low pressure combustion chamber 15 with its input is connected to the output of compressor 1 and by means of the output it is connected to the input of turbine stage 10 of the corresponding pressure. Bypass channels 16, 17, 18, 19 may be performed as annular section passages or divided into several parallel channels with their combustion chambers of low pressure. Motor shaft 20 is connected to electric generator 21. In high pressure combustion chamber 11 the nozzles for high calorific gas turbine fuel supply are arranged. Each of combustion chambers of low pressure 12, 13, 14 and 15 has its nozzles—devices for fuel supply for combustion in these chambers. Combustion chambers 11, 12 and 15 are also provided with means of ignition of the flame.

The engine works as follows. At the output of high pressure combustion chamber 11 after starting the engine the hot gases have a temperature, which is not dangerous for long-term non-stop operation of the engine. But in this case the excess air ratio is as large—about 3. Therefore, the air will flow into low pressure combustion chamber 12 through bypass channel 16. For example, about 4% with respect to the main flow which passes continuously through high pressure compressor 5. Then, in combustion chamber 12 it is possible to organize the burning even of high calorific fuel in the conditions of oxygen deficiency. After exiting low pressure combustion chamber 12 the incompletely burned fuel meets and is mixed with the working fluid having a good excess of oxygen, used on high pressure turbine 6. The fuel afterburning will occur in secondary combustion passage 22. The working fluid with newly elevated temperature will flow to turbine inlet 7. At the same time there will be a technical result, which was not seen on the engines using stepwise afterburning of low calorific fuel in conditions of oxygen deficiency. Namely, low pressure combustion chamber 12 will raise the temperature of the working fluid after high pressure turbine stage 6, i.e. in this respect it will operate as a combustion chamber connected in series to high pressure combustion chamber 11. But at the same time the redistribution of flow rate of working fluid between the specified chambers will be performed similarly in parallel with the operating combustion chambers. That will eliminate self-oscillations during the combustion of fuel in several combustion chambers. The application of the specified technical effect on the gas turbine engines using high calorific fuels will raise their efficiency to 80%. In low pressure combustion chamber 13 the fuel combustion occurs in the environment where a large portion of oxygen has already been burnt. The air entering air duct 17 contributes to the stabilization of the combustion process. Fresh air flows to the input of low pressure combustion chamber 14 through air duct 18. Together with the incoming fuel it forms the central part of the jet inside combustion chamber 14. The main part of the working fluid flows closer to combustion chamber walls 14. The working fluid, used on turbine stage 9, almost doesn't have any unburned oxygen. Therefore, in low-pressure combustion chamber 15 the combustion is carried out at a stoichiometric ratio of fuel and air entering through duct 19. Based on this the air flow through air duct 19 is selected. The running of the engine at the rated power setting is carried out at a nominal temperature of gases at the inlet to the turbine stage. Reducing the power is performed by means of decreasing the temperature of working fluid firstly before the last turbine stage 10, then before the next to the last one stage 9 and so on. Under the conditions of speed constancy of shaft 20. It should be understood that there are many other embodiments. For example, low pressure combustion chambers 13 and 14 may be performed and connected similarly to combustion chamber 12. Combustion chamber 15 can also operate in conditions of lack of oxygen in the air. Instead the last stage of turbine 10 and electricity generator 21 the free turbine stage with its load may be installed.

Subsonic two-shaft aircraft engine comprises multistage high pressure compressor 23 on shaft 22 and single-stage high pressure turbine 24. On the other shaft 25 multi-stage low-pressure compressor 26 with fan wheel 27 is mounted. Five stages of low pressure turbine 28 are installed on the same shaft. The engine also includes high pressure combustion chamber 29, low pressure combustion chamber 30, bypass air channel 31. At the inlet and outlet of annular channel 31 self-acting shutters 32 and 33 respectively are mounted. A set of shutters 32 and 33 are uniformly distributed along the circumference of the cross section of channel 31 and fixed as shown in the diagram and are able to pass the air flow in one direction only—from the compressor to the turbine. When the air flow tries to move in the opposite direction, they independently close channel 31. Both combustion chambers 29 and 30 are provided with nozzles 29 and 30 for aviation kerosene supply and flame ignition means. The engine is designed and manufactured for maximum settlement mode when flying at the altitude of 11,000 meters at the speed of 0.8 Mac number. That differs from the usual design of subsonic engines when maximum settlement mode is accepted based on the conditions of the ground takeoff.

The engine works as follows. During takeoff from the airport the first high pressure combustion chamber 29 starts up. Shutters 32 and 33 prevent the movement of the working fluid in the direction from the turbine to the compressor. Shaft 25 speed is strongly reduced. Then low pressure combustion chamber 30 is turned on, low pressure compressor speed 26 increases. Not all the air is picked up by high pressure compressor. 23. Shutters 32 and 33 open independently, part of the air moves along bypass channel 31 stabilizing the combustion process in combustion chamber 30. The temperature of hot gases at the outlet of combustion chambers 29 and 30 is supported not at the highest level during takeoff. As a result, the turbine blades do not overheat, equilibrated speed of compressors 26 and 23 is reduced. This will allow to raise the flight efficiency on takeoff, more complete use of the strength of the metal blades of the engine, to run the engine with high bypass ratio. With increase of the altitude the temperature and density of the air will be decreasing at the engine intake. This involves increasing of the temperature of the hot gases at the output of combustion chambers 29 and 30 by adjusting the fuel consumption. Since the temperature of the air from the compressor used for the cooling of turbines will also decrease. Only at the height of 11,000 meters at the inlet temperature of the engine, for example, 244 K, the engine will be led to the maximum rated working condition which will allow to create the engine with a large power thrust in flight and increase the safety of these flights. It's offered to reduce the engine operation by means of decreasing of the temperature of the gases at the outlet of low pressure combustion chamber 30. The temperature of the working fluid before high pressure turbine stage 24 in a wide range of thrust should be maintained constant. This will provide reliable burning in combustion chamber 30. Fuel economy will be provided by means of increasing of thermal and flight efficiencies. In embodiments in channel 31 the fuel supply nozzles may also be mounted. The engine can be equipped with a gearbox.

The list of patent documents which can be called relevant with respect to the claimed invention: GB2346177, SU1560749, U.S. Pat. No. 6,385,959, WO9721912, WO9721913, WO9721914, RU2097590, RU2166655.

1. A gas-turbine engine comprising at least one low-pressure air compressor, at least one low-pressure combustion chamber, at least one stage of a low-pressure turbine, a high-pressure air compressor, a high-pressure turbine, and a high-pressure high-speed air-gas combustion chamber located between them, a high-energy fuel feeder for combustion in this chamber, where continuous passage of a main working medium flow is arranged through the high-pressure air compressor while the engine is running, as also there is a possibility to pass by a part of working medium of the engine from the output of the low-pressure compressor bypassing the high-pressure air compressor, high-pressure combustion chamber and high-pressure turbine with a subsequent feed of appropriate low pressure to the turbine stage directly or through the low-pressure combustion chamber. The output of this combustion chamber is connected to the input of the specified low-pressure turbine stage characterized in that the engine is additionally equipped with at least one fuel feeder for combustion in the low-pressure combustion chamber with fuel bypassing the output to the high-pressure turbine.

2. The engine as per item 1 characterized in that the output of the compressor of appropriate pressure is connected to the output of the low-pressure combustion chamber, and the output of the turbine stage of appropriate pressure is connected to the specified combustion chamber.

3. The engine as per item 1 characterized in that the output of the turbine stage of appropriate pressure is connected to the output of the low-pressure combustion chamber, and the output of the compressor of appropriate pressure is connected to the specified combustion chamber.

4. The engine as per item 1 characterized in that the output of the compressor of appropriate pressure and the output of the turbine stage of appropriate pressure are connected to the output of the low-pressure combustion chamber.

5. The engine as per item 1 characterized in that it is at least two-shaft, coaxial, the high-pressure turbine is single-stage, on one shaft with a high-pressure multi-stage compressor, the low-pressure air compressor and a low-pressure multi-stage compressor are located on the other shaft, the output of the low-pressure air compressor is connected to the output of the third low-pressure turbine stage using a bypass air port with an output via the low-pressure combustion chamber.
